(19) United States
(12) Patent Application Publication
(10) Pub. No.: US 2008/0222519 A1
(43) Pub. Date: Sep. 11, 2008

(54) REMOTE INTELLIGENT CONTENT AUTHORING AND CONVERSION SYSTEM

(75) Inventors: Jim Belcher, Santa Monica, CA (US); Howard Soroka, Santa Monica, CA (US); Shari Young, Van Nuys, CA (US)

Correspondence Address: DARBY & DARBY P.C., P.O. BOX 770, Church Street Station, New York, NY, 10008-0770, US

(73) Assignee: Universal Music Group, Inc., Santa Monica, CA (US)

(21) Appl. No.: 12/057,222

(22) Filed: Mar. 27, 2008

Related U.S. Application Data
(63) Continuation of application No. 10/712,648, filed on Nov. 12, 2003.
(60) Provisional application No. 60/425,715, filed on Nov. 12, 2002.

(51) Int. Cl. G06F 7/00; G06F 17/30

(52) U.S. Cl. 715/249; 707/3; 707/E17.006

(57) ABSTRACT

A method and apparatus for organizing, authoring and converting different format content files into one or more common output formats which simplifies the entire authoring and production processes. The content files are uploaded to the authoring system and identified. The content files are then sent to a central server and the authoring system relates all the related content files with each other. An embodiment allows the authoring system to populate a reference database with the pertinent information that identifies the relationship between the files. Once the content is produced, identified and stored, a user can then author a collection. The authoring system is located on a central server which contains all of the content and reference databases and performs the content conversion. The authoring system server can be accessed via the Internet or an intranet so the user can access the authoring system from anywhere there is a network connection.

This application claims priority pursuant to 35 U.S.C. §119 from Provisional Patent Application Ser. No. 60/425,715 filed Nov. 12, 2002, the entire disclosure of which is hereby incorporated by reference.

### FIELD OF THE INVENTION

The present invention generally relates to the fields of content authoring, content transformation, and communications, and more specifically to the arrangement and conversion of media into any one of multiple common commercial formats.

### BACKGROUND OF THE INVENTION

The proliferation of digital content and the transmission of such content to users around the world have resulted in many different types of consumer formats for content. Much of the content available is in multimedia (i.e., audio and/or video) format, including music tracks, video, images, World Wide Web pages, text files, and Uniform Resource Locators (URLs) to direct a user to a web site. Once content has been stored in one type of signal format, the various types of content must be arranged or “authored” into a commercial product and then output to one of many common formats. The common formats are also known in the music industry as Enhanced Media Formats (EMF). One of the reasons for having a common format for content is the need to mass produce the content for general consumption by the public. Consumers want content in numerous different formats depending on the intended use. Examples of some of the common formats for the music industry are Enhanced Compact Discs (ECD), DataPlay Disks, QuickTime files, Digital Music Downloads (DMD), Super Audio Compact Discs (SACD), and Digital Video Disk (DVD)-Audio discs. The mass production of content is a very large industry, with music and video being two of the major types of content that are mass produced. Both the music and video industries utilize content in many different formats, and both industries require the conversion of the different format content into one or more standard content formats for mass production.

Currently, content management, authoring, and conversion to a common format is a time and resource consuming process. In the music industry, content is recorded and saved in multiple formats. The content includes audio tracks for music, video clips, text, still images, World Wide Web pages, text, and URLs. Once the content is saved, the various pieces of content must be authored to create a collection, or an album, that is both aesthetically and technically cohesive. Currently, a human operator logs into a dedicated workstation to begin the authoring process. The operator queries the local content library stored on the workstation for all of the particular pieces of content needed to form the desired collection. The operator must search for each piece of content individually, for example, the audio tracks, related music videos, lyrics, text files, World Wide Web pages and URLs that link a user to the related artist's web site. Once the collection is created, it is converted into the desired output format. This is a time consuming process because the operator must now assemble all of the content and process the content to convert it from its original format to the desired output format. The workstation cannot be utilized for other tasks until the assembly and conversion steps are completed. Due to the dedicated nature of the workstation, only one operator at a time can be on a workstation. Thus, the company must purchase additional workstations to increase productivity. Because current workstations cannot produce more than one type of output format, the content must be re-authored into a collection on a second workstation. Entirely different types of single-purpose workstations are required to author and output each format type.

The practice of including URLs with the content adds another time consuming task to the authoring process. Current music industry practice is that the URLs included with a collection do not point directly at an artist's web site. Instead, the URL supplied with the collection directs the user to a redirect server controlled by the music company and the redirect server redirects the user to the artist's web site. Thus, when a collection is produced and one or more URLs are included with the collection, the music company redirect server must be instructed to respond to those new URLs and give directions to redirect the user to the appropriate artist's site. Presently, the instructions to activate a new URL and the redirect information are manually inputted. Thus, there is a need for a method and a system to simplify all of the above procedures and streamline them into an efficient process.

### SUMMARY OF THE INVENTION

The present invention relates to a method and apparatus for organizing, authoring and converting different format content files into one or more common output formats. The method of the invention simplifies the entire authoring and production processes.

First, content is produced in any number of acceptable formats, e.g., music and videos are recorded, photos are captured, World Wide Web pages and text are created. Once recorded, the content files are uploaded to the authoring system and identified. The authoring system can identify the content in numerous ways. In one embodiment, the content file name and extension are used to sort and identify the type of content (i.e., audio, video, photo, etc.) and the artist associated with the content. For example, for the group U2, there would be a .WAV file for each audio track, .AVI or .MPG files for the videos and .JPG files for the photos, and all of the files are named to relate to U2 and the particular content. Another embodiment encodes each of the separate content files with information that describes the content and artist and then the authoring system of the present invention accesses the encoded information and determines the files' content and artist. Regardless of how the content is identified, the content files are sent to a central server and the authoring system relates all the related content files with each other. For example, the authoring system identifies all of the tracks recorded by a particular artist as well as the related music videos, lyrics, text files, World Wide Web pages and URLs and identifies all of the files as related files. An embodiment allows the authoring system to populate a reference database with the pertinent information that identifies the relationship between the files. Each file is accessed and identified once by the authoring system and then the relationship information is stored in a database and then displayed to the user. A further embodiment allows the authoring system to query other servers for content. The other servers are known to the authoring system, but the content of the other servers may not be known. This feature allows the storage of the content to be decentralized, thus reducing the necessary storage capacity of any one server and providing added security against loss by allowing the content to be distributed, such that the loss or inaccessibility of one server will not result in the loss of every content file. Once the content is produced, identified and stored, a user can then author a collection. The authoring system is located on a central server which contains all of the content and reference databases and performs the content conversion as described herein. The present invention provides the authoring function in a centralized manner, instead of a single workstation. This centralization allows multiple users to author collections without the expense of purchasing multiple workstations specifically configured to author and produce collections. The authoring system server can be accessed via the Internet or an intranet so the user can access the authoring system from anywhere there is a network connection. Additionally, the system requirements of the authoring system client are minimized because it is a server-based authoring system. Thus, a user can access, author and produce a collection on the authoring system using a personal computer, a Personal Digital Assistant (PDA), a Tablet PC or any other computing device, including wired or wireless devices, with a web browser and access to the network.

The authoring process is also streamlined. A user is allowed access to all or selected groups of content depending on the user's access clearance. For example, a user working for one music label within a parent company will not be able to access content designated for another label within the same company.

A user starts an authoring session by specifying information related to the characteristics of the final intended product format, such as label, artist, and title, etc. The authoring system then accesses the content on the server, or in an alternate embodiment, the reference database, and returns to the user a list of all the content available that is related to the product format chosen. Additionally, the user can choose to filter out certain types of content, e.g., the authoring system will only list audio tracks. The user can then pick and choose among all the related content and select the content files to include in the collection. Once the collection is completed, it can be saved. At this point, the authoring system has not converted any of the content files from their original formats.

Upon completion of the user's input, the authoring system will verify the entire collection for correctness, and produce a final master copy in the chosen format for replication. The final master copy is suitable for manufacturing. The user can perform various tasks using the master copy. The master copy can be transmitted to another location for further editing or production, or it can be converted to physical form (e.g., a CD-Recordable disc) and tested by the user. The authoring system allows a user to produce multiple commercial and non-commercial formats from the same collection of content. Thus, audio files can be converted to, e.g., DTS, Dolby AC-3, AAC, QDX, MP3, WMA and Real Audio formats. Video files can be edited and effects added as well as converted into, e.g., MPEG1, MPEG2, WMV, Real Video, and QuickTime formats. Image files can also be edited and converted into TIFF, .GIF, .BMP and .JPG. Additionally, the authoring system can watermark the individual content files. The watermark can be visible or invisible and is encoded into the content for screening and forensic detection purposes.

The authoring system produces the collection on the server, thus the user's terminal is not burdened with producing the collection, and the user can begin another authoring session or perform other tasks. Additionally, once the initial collection is produced, the user can then return to the authoring system, access the collection file and produce the same collection again in another format without changing terminals or starting a new session. The system allows multiple authors to work on the same content collection and/or final product as long as all such users have security and access permissions for the same content. Multiple users can work simultaneously or at different times on the same or different collections, and because the system maintains a permanent database of all content and product-related information, a single product need not be authored in a single user session. Another embodiment of the present invention increases security by dividing the authoring and the production tasks, such that users need one type of clearance to author a new collection and a separate clearance to produce the formatted collection. Further, since the authoring system is server based and modular, it can be easily updated to produce new common formats as they are introduced. Thus, a user can create a collection in every available format in one session. New workstations do not have to be purchased with the introduction of each new common format. Also, licenses can be negotiated for any proprietary formats so the music company can produce in the proprietary format using the authoring system instead of transmitting the collection to the owner of the proprietary format and awaiting the owner to produce the collection and transmit it back. Thus, the music company can remove the additional delays caused by having to use an outside party to produce the collection.

Another embodiment of the authoring system provides for the intelligent automation of the URL configuration process which refers to automatically updating the music company's redirect server. The authoring system recognizes when a user defines a URL to include in the collection. Once the authoring system completes production of the collection, the authoring system configures the redirect web server. The authoring system communicates with the company's redirect server and instructs the redirect server to both respond to the URL that was included in the product, and to redirect web browser applications to the intended target URL (which may change over time). Automating the URL configuration process streamlines the production process by eliminating the need for multiple persons to process the URL activation request and reduces the possibility of errors in communicating the correct information to the redirect server. The URL automation system also allows for immediate distribution of the content. If the collection is produced in an Internet ready format, it can then be distributed soon after production, without the delay of waiting for the manual processing of the URL redirect request.

### BRIEF DESCRIPTION OF THE DRAWING FIGURES

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is a schematic diagram of an embodiment of the present invention;

FIG. 2 is a schematic diagram of another embodiment of the present invention; and

FIG. 3 is a flow diagram of an embodiment of the present invention.

### DETAILED DESCRIPTION OF THE PREFERRED EMBODIMENTS

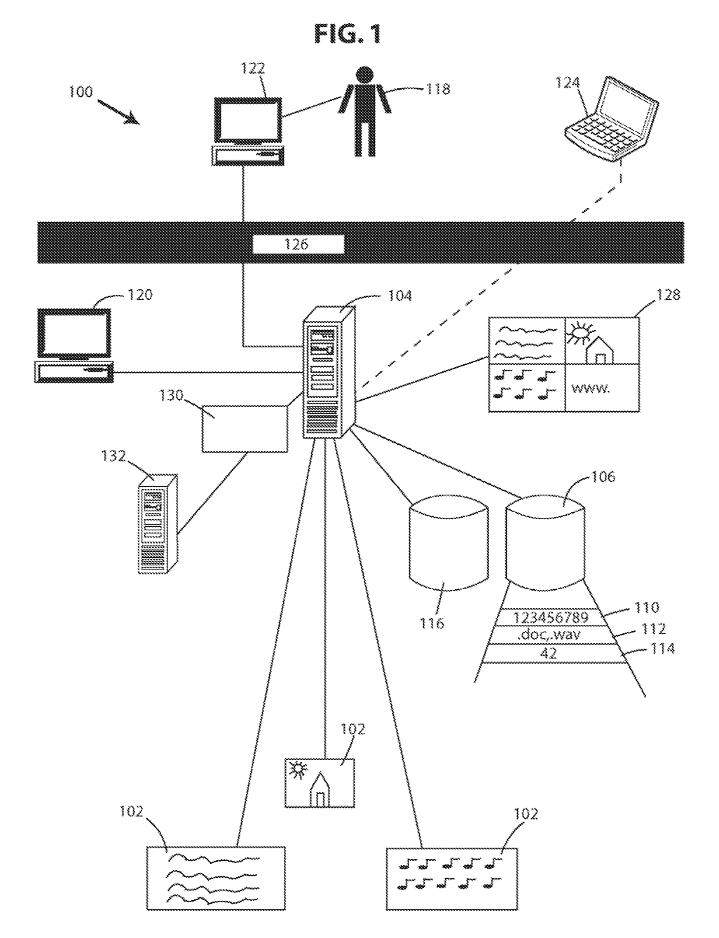

Referring now to FIG. 1 therein is shown the overall authoring system 100. First, content files 102 are produced in any number of acceptable formats, e.g., music and videos are recorded, photos are captured, World Wide Web pages and text are created. The acceptable formats will be apparent to those of ordinary skill in the arts of producing content files. Once recorded, content files 102 are uploaded to the authoring system 104 and identified. Content files 102 are identified by numerous factors and by looking at both the file name and contents of the file. For example, content files 102 can be identified by type (audio, video, .WAV, .JPG,) and can also be identified by content (artist, U2, track 3). The acceptable identifiers will be apparent to those of ordinary skill in the arts of identifying content files.

Once uploaded, authoring system 104 relates the identified files together. For example, three separate audio tracks, each with a unique identifier, are recorded by the same artist. Authoring system 104 identifies that the tracks are related by artist and groups content files 102 accordingly. The example further applies to video, metadata, web pages, and URLs. Authoring system 104 identifies the artist and groups the related data together. The related content files 102 are, for example, stored in the same directory or on the same server.

An embodiment allows the authoring system to populate a reference database 106 with the pertinent information regarding content files 102. For example, references database can be populated with a unique identifier 110, a content format 112, and a relationship identifier 114 that identifies the relationship between the files.

A further embodiment allows the authoring system to query other servers or databases 116 for content files 102. Authoring system 104 can periodically check other servers 116 for content files 102 not entered in reference database 106. Further, authoring system 104 can receive a request from a user 118 for content files 102 not present on authoring system 104 or entered in reference database 106 and authoring system 104 can search other servers 116 for the requested content.

Once content files 102 are identified and related, user 118 can start an authoring session. Authoring system 104 provides the authoring function in a centralized component of a network environment, instead of a single workstation. Each workstation 120, 122, 124 can be used to author any type of media and format for that media. For example, workstation 120, 122, 124 can author audio content files 102, video content files 102 and different formats for each type of file. Thus, a separate workstation is not required for each media type and format. Authoring system 104 can be accessed via the Internet or an intranet so the user can access the authoring system from anywhere there is a network connection. Thus, user 118 can access, author and produce a collection on the authoring system using a personal computer, a Personal Digital Assistant (PDA), a Tablet PC or any other computing device, including wired 120 or wireless devices 122, 124 with a web browser and access to the network through firewalls 126 and other virtual security measures.

Once the authoring process is complete, at least one collection file 128 is created. Collection file 128 is one or more files containing individual content files 102 that have been authored by user 118. Collection file 128 also links the related content files 102 to be produced as a final product. For example, numerous audio content files 102 can be collected to form an album and numerous video and still image content files 102 can be collected and linked to the audio content files. The authoring system then verifies the at least one collection file 128 for correctness, and produces a final master copy 130 in the chosen format for replication. The final master copy is suitable for manufacturing and can be sent to a production location 132 for storage, distribution, or replication.

User 120 can perform various tasks using final master copy 130. Master copy 130 can be transmitted to another location for further editing or production, or it can be converted to physical form (e.g., a CD-Recordable disc) and tested by user 120. Authoring system 104 allows user 120 to produce multiple commercial and non-commercial formats from the same collection file 128. Thus, audio files can be converted to, e.g., DTS, Dolby AC-3, AAC, QDX, MP3, WMA and Real Audio formats. Video files can be edited and effects added as well as converted into, e.g., MPEG1, MPEG2, WMV, Real Video, and QuickTime formats. Image files can also be edited and converted into TIFF, .GIF, .BMP and .JPG. Additionally, authoring system 104 can watermark the individual content files 102.

Collection file 128 can also be stored for later reference. Thus, once a new format is released, the content can be converted to the new format without re-authoring the collection.

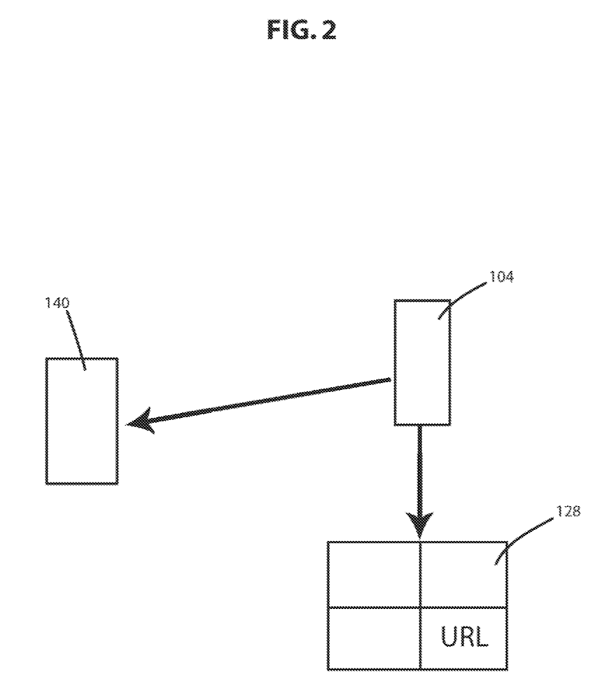

Referring now to FIG. 2, another embodiment of authoring system 104 provides for the intelligent automation of the URL configuration process. The intelligent automation refers to automatically updating a company's redirect server 140. Authoring system 104 recognizes when user 120 defines a URL to include in collection file 128. Once authoring system 104 completes the production of the collection file 128, authoring system 104 configures redirect server 140. Authoring system 104 communicates with redirect server 140 and instructs redirect server 140 to both respond to the URL that was included in the product, and to redirect web browser applications to the intended target URL (which may change over time). Automating the URL configuration process streamlines the production process by eliminating the need for multiple persons to process the URL activation request and reduces the possibility of errors in communicating the correct information to the redirect server. The URL automation system also allows for immediate distribution of the content. If the final master copy 130 is produced in an Internet ready format, it can be distributed soon after production, without the delay of waiting for the manual processing of the URL redirect request.

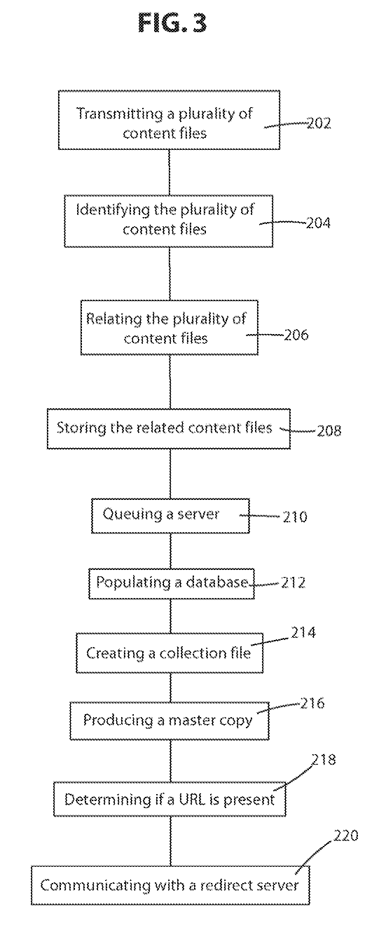

Referring now to FIG. 3, a method of remotely authoring content is illustrated. The method includes, transmitting a plurality of content files in various formats to an authoring system (step 202). The content files can be in any format and contain a variety of content, e.g. audio, video, still images, text, and URLs. Once uploaded, the authoring system identifies the plurality of content files (step 204) and relates the plurality of content files into like groups (step 206). The related content files can be stored together (step 208). Additionally, either a user can request or the authoring server can be configured to query a server for additional content files (step 210). The other server can contain files not present in the authoring system and can now allow the authoring system, and thus the user, access to the additional content files to be included in the authoring process. Regardless of whether the content files are located on the authoring system or on another server, a reference database is populated with information related to the plurality of content files (step 212). The information can relate to, for example format or media.

Once the above steps are performed, the user can start creating at least one collection file including content files (step 214). The collection file is one or more files containing content files arranged in a particular way by the user. For example, individual content files can be individual tracks for an album and the collection file can be the album. A further example is that the content files are audio tracks linked with their corresponding videos and lyric text. There can be more than one content file depending on various parameters. Once the collection file is created, a master copy of the collection file can be produced in a format specified by the user (step 216). This step can be repeated on the same collection file multiple times for multiple formats. Thus, the user does not require additional workstations or sessions to create master copies in various formats. Additionally, the user does not have to recreate the same collection file for each format; the same collection file can be used repeatedly.

The method can further include determining if a URL is in the collection file (step 218) and then communicating with a redirect server to activate the URL (step 220). This allows the URL to be activated and available for consumers to access at the same time the master file is prepared. This reduces the wait time for the distribution of content and removes handling by multiple user which can increase the chance of error.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another is also fully intended and contemplated. It is also to be understood that the drawings are exemplary and they are conceptual in nature. It is the intention, therefore, to be limited only as indicated by the scope of the claims appended hereto.

1. A system for the remote authoring of content, comprising:
a plurality of content files; and
an authoring system storing the plurality of content files, comprising;
an identification system to identify the plurality of content files;
a relation system to relate related content files;
a query system to request content files from a server;
a reference database to store information about the plurality of content files;
a collection system to convert the plurality of content files into at least one collection file;
a conversion module to covert the at least one collection file into a master copy, wherein the master copy is in one of a plurality of formats; and
a URL configuration system to identify a URL entered by a user into the at least one collection file and to communicate with a redirect server to activate the URL.

2. The system of claim 1, further comprising a remote workstation for a user to access the authoring system.

3. A method of remotely authoring content, comprising:
transmitting a plurality of content files in various formats to an authoring system;
identifying, by the authoring system, the plurality of content files;
relating, by the authoring system, the plurality of content files;
storing the related content files together;
querying a server for additional content files;
populating a reference database with information related to the plurality of content files;
creating, by a user, at least one collection file including content files;
producing, by the authoring system, a master copy of the collection file in a format specified by the user;
determining if a URL is in the collection file;
communicating with a redirect server to activate the URL.
